(19) United States
(12) Patent Application Publication
(10) Pub. No.: US 2023/0249941 A1
(43) Pub. Date: Aug. 10, 2023

(54) TAPE CARTRIDGE, TAPE REEL, AND METHOD OF PRODUCING REEL HUB

(71) Applicant: Sony Group Corporation, Tokyo (JP)

(72) Inventors: Hiroshi KUMAGAI, Tokyo (JP); Taeko TAKAHASHI, Tokyo (JP); Yuji IWAHASHI, Tokyo (JP)

(21) Appl. No.: 18/014,565

(22) PCT Filed: Jun. 28, 2021
(86) PCT No.: PCT/JP2021/024275

§ 371 Date: Jan. 5, 2023

(30) Foreign Application Priority Data
Jul. 6, 2020 (JP) 2020-116640

(51) Int. Cl. B65H 75/50; G11B 5/78; B29C 45/14

(52) U.S. Cl. CPC B65H 75/50; G11B 5/78; B29C 45/14065; B65H 2701/378; B29C 2045/14122; B29K 2705/00

(57) ABSTRACT

[Object] To provide a method of producing a tape cartridge that includes a reel hub, a tape reel, and a reel hub, which are capable of achieving desired molding quality in single molding.

[Solving Means] A tape cartridge according to an embodiment of the present technology includes: a first flange; a second flange; and a reel hub on which a tape is wound. The reel hub is disposed between the first flange and the second flange. The reel hub includes a cylindrical metal ring and a molded body formed of a synthetic resin. The molded body includes a first resin portion formed on an inner peripheral surface of the metal ring and a second resin portion formed on an outer peripheral surface of the metal ring. The first resin portion includes a plurality of first recessed portions formed at intervals in a circumferential direction of the metal ring.

### TECHNICAL FIELD

The present technology relates to a tape cartridge that includes a reel hub in which a metal ring is insert-molded, a tape reel, and a method of producing a reel hub.

### BACKGROUND ART

As a magnetic tape cartridge used as an external recording medium of a computer or the like, those rotatably housing a single tape reel on which a magnetic tape is wound in a cartridge case have been known. The tape reel includes a reel hub on which the magnetic tape is wound, and an upper flange and a lower flange disposed at both ends of the reel hub.

In recent years, the thinning of a magnetic tape and the increase in the tape length have been promoted in accordance with the increase in the recording capacity of a tape cartridge. Meanwhile, the deformation amount of the reel hub due to tightening (winding pressure) of the magnetic tape increases, and thus, there is a possibility that, for example, the width of the tape region located on the inner peripheral side of the tape reel close to the reel hub is extended, which adversely affects the recording/reproduction characteristics of the magnetic tape.

Meanwhile, a tape reel that includes a reel hub in which a cylindrical metal ring is insert-molded has been known. The reel hub having such a configuration can be prevented from being deformed due to the winding pressure of the magnetic tape, because the rigidity of the hub surface is increased. As a method of producing a reel hub in which a metal ring is insert-molded, for example, Patent Literature 1 discloses a method of molding, while a metal ring is inserted in a mold, a primary molding portion that covers the inner peripheral surface of the metal ring by primary molding and then molding a secondary molding portion that covers the outer peripheral surface of the metal ring by secondary molding.

### CITATION LIST

### Patent Literature

Patent Literature 1: Japanese Patent Application Laid-open No. 2007-335054

### DISCLOSURE OF INVENTION

### Technical Problem

However, in the production method described in Patent Literature 1, since the molding process requires two processes of primary molding and secondary molding, a mold for primary molding and a mold for secondary molding are necessary, which causes a problem that a reduction in the production cost and an improvement in the productivity cannot be achieved. Further, in the case of attempting to simultaneously mold a resin portion that covers the inner peripheral surface of the metal ring and a resin portion that covers the outer peripheral surface of the metal ring by single molding, when injecting a resin around the metal ring disposed in the mold, the position of the metal ring changes due to the injection pressure of the resin, which makes it difficult to mold a resin portion having a desired thickness on the inner and outer peripheries of the metal ring with high accuracy.

In view of the circumstances as described above, it is an object of the present technology to provide a tape cartridge that includes a reel hub, a tape reel, and a method of producing a reel hub, which are capable of achieving desired molding quality in single molding.

### Solution to Problem

A tape cartridge according to an embodiment of the present technology includes: a first flange; a second flange; and a reel hub on which a tape is wound.

The reel hub is disposed between the first flange and the second flange. The reel hub includes a cylindrical metal ring and a molded body formed of a synthetic resin. The molded body includes a first resin portion formed on an inner peripheral surface of the metal ring and a second resin portion formed on an outer peripheral surface of the metal ring. The first resin portion includes a plurality of first recessed portions formed at intervals in a circumferential direction of the metal ring.

The plurality of first recessed portions may include groove portions extending in an axial direction of the metal ring.

The plurality of first recessed portions may be formed from one end of the first resin portion in the axial direction to a vicinity of the other end of the first resin portion in the axial direction.

The molded body may further include a third resin portion formed on a surface of the metal ring on one end side in the axial direction. The third resin portion includes a plurality of holes formed at intervals in a circumferential direction of the metal ring.

The first flange may include a plurality of protruding portions that protrudes toward the one end of the first resin portion in the axial direction. The first resin portion further includes a plurality of second recessed portions that engages with the plurality of protruding portions.

The plurality of second recessed portions may include groove portions common to the plurality of first recessed portions.

The first flange may include a plurality of first engagement portions provided radially inward of the reel hub, and the second flange may include a plurality of second engagement portions that is provided radially inward of the reel hub and engages with the plurality of first engagement portions. The reel hub is disposed between the first flange and the second flange coupled to each other via the plurality of first engagement portions and the plurality of second engagement portions.

A tape reel according to an embodiment of the present technology includes: a first flange; a second flange; and a reel hub disposed between the first flange and the second flange.

The reel hub includes a cylindrical metal ring and a molded body formed of a synthetic resin. The molded body includes a first resin portion formed on an inner peripheral surface of the metal ring and a second resin portion formed on an outer peripheral surface of the metal ring. The first resin portion includes a plurality of first recessed portions formed at intervals in a circumferential direction of the metal ring.

A method of producing a reel hub according to an embodiment of the present technology includes: disposing a metal ring in a first mold that includes a columnar portion facing an inner peripheral surface of the metal ring, a first base portion that is integrally formed with the columnar portion and faces one end of the metal ring in an axial direction, and a plurality of ridges that extends along the axial direction and protrudes from an outer peripheral surface of the columnar portion toward the inner peripheral surface of the metal ring;

combining a second mold with the first mold, the second mold including a cylindrical portion facing an outer peripheral surface of the metal ring and a second base portion that is integrally formed with the cylindrical portion and faces the other end of the metal ring in the axial direction; and

injecting a synthetic resin material between an outer periphery portion of the columnar portion and an inner peripheral surface of the cylindrical portion via an injection port formed between the columnar portion and the second base portion.

The injection port may be formed along an entire circumference of the other end of the metal ring.

The first base portion may include a plurality of protruding portions that supports the surface of the metal ring on the one end side.

### BRIEF DESCRIPTION OF DRAWINGS

FIG. 1 is an entire perspective view of a tape cartridge according to an embodiment of the present technology, Part A being a perspective view when viewed from the upper surface side, Part B being a perspective view when viewed from below.

FIG. 2 is an exploded perspective view of the tape cartridge.

FIG. 3 is a cross-sectional side view of a tape reel in the tape cartridge.

FIG. 4 is an exploded perspective view of the tape reel. An entire perspective view of the tape reel.

FIG. 5 is an entire perspective view of the tape reel.

FIG. 6 is a cross-sectional perspective view of a reel hub in the tape reel.

FIG. 7 is an entire perspective view of the reel hub as viewed from the end surface side on the lower flange side.

FIG. 8 is a longitudinal cross-sectional view of the main portion in FIG. 7.

FIG. 9 is an entire perspective view showing a first mold for molding the reel hub.

FIG. 10 is a cross-sectional view taken along the line A-A in FIG. 9.

FIG. 11 is an entire perspective view of the first mold in which a metal ring is set.

FIG. 12 is a cross-sectional view of FIG. 11, which corresponds to FIG. 10.

FIG. 13 is a schematic diagram describing a method of molding the reel hub.

FIG. 14 is a schematic diagram describing the method of molding the reel hub.

FIG. 15 is an entire perspective view of an insert-molded body prepared by the method shown in FIG. 14.

FIG. 16 is a longitudinal cross-sectional view of the insert-molded body.

FIG. 17 is a diagram describing a problem of a tape reel including a reel hub that is integrally formed with a lower flange and is formed of a synthetic resin.

FIG. 18 is a schematic diagram describing a change in the width dimension of a magnetic tape due to deformation of the reel hub.

FIG. 19 is a schematic configuration diagram of the magnetic tape.

FIG. 20 is a schematic diagram of the magnetic tape as viewed from the above.

FIG. 21 is a schematic diagram describing a method of testing the reel hub.

FIG. 22 is a perspective view of a reel hub showing a modified example of FIG. 7.

FIG. 23 is a perspective view of an insert-molded body prepared by a pin-point gate system.

### MODE(S) FOR CARRYING OUT THE INVENTION

Hereinafter, an embodiment according to the present technology will be described with reference to the drawings.

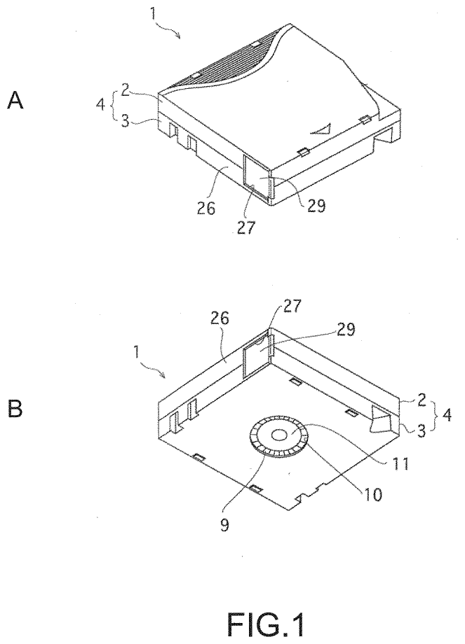

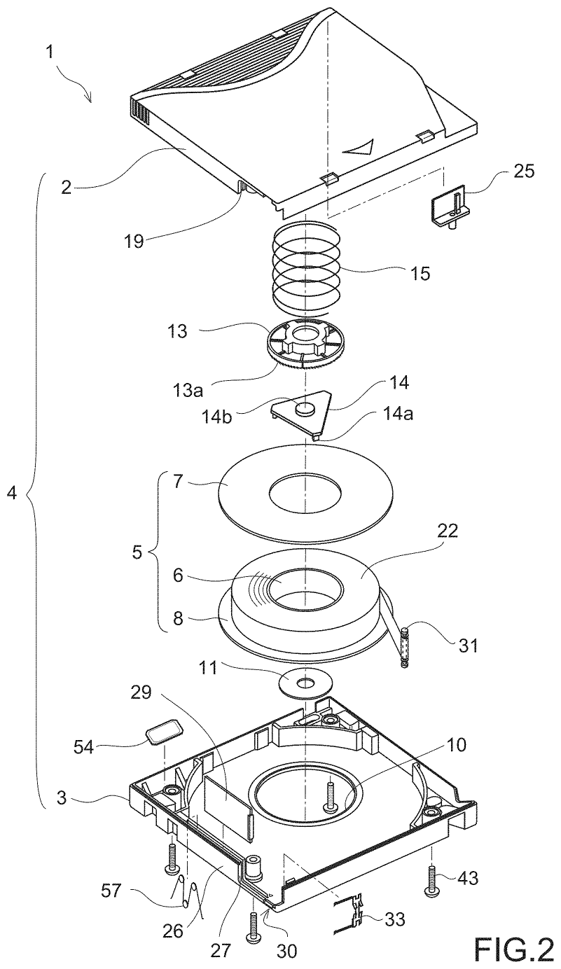

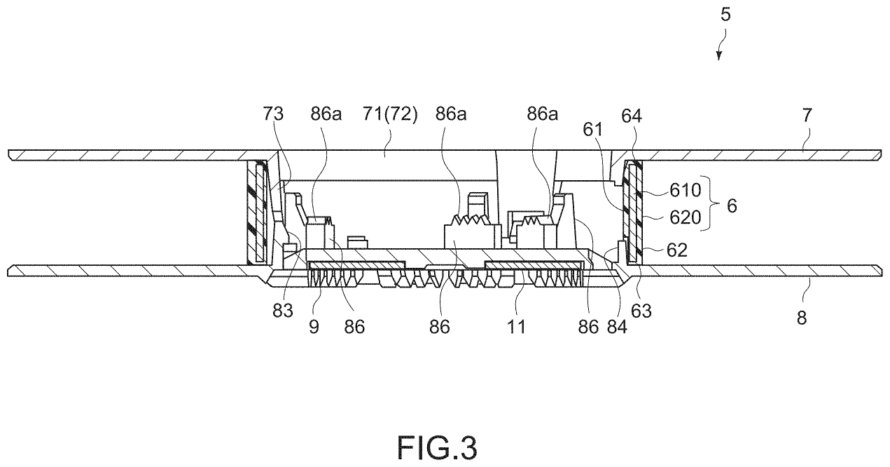

Parts A and B of FIG. 1 are each an entire perspective view of a tape cartridge 1 according to an embodiment of the present technology, Part A of FIG. 1 being a perspective view of the tape cartridge 1 as viewed from the upper surface (upper shell 2) side, Part B of FIG. 1 being a perspective view of the tape cartridge 1 as viewed from the lower surface (lower shell 3) side. FIG. 2 is an exploded perspective view of the tape cartridge 1, and FIG. 3 is a cross-sectional side view of a tape reel 5.

[Overall Configuration]

The tape cartridge 1 according to this embodiment is configured as a magnetic tape cartridge conforming to the LTO (Linear Tape Open) standard. The tape cartridge 1 has a configuration in which a single tape reel 5 on which a magnetic tape 22 is wound is rotatably housed inside a cartridge case 4 formed by connecting the upper shell 2 and the lower shell 3 to each other with a plurality of screw members 43.

The tape reel 5 includes a cylindrical reel hub 6, an upper flange 7 disposed at the upper end (opening end) of the reel hub 6, and a lower flange 8 disposed at the lower end of the reel hub 6. The upper flange 7 and the lower flange 8 each include an injection molded body formed of a synthetic resin material, and the reel hub 6 includes an injection molded body formed of a synthetic resin material, which incorporates a metal ring obtained by insert-molding.

A chucking gear 9 that engages with a reel rotation drive shaft of a tape drive device (not shown) is annularly formed in the center of the lower surface of the tape reel 5, and is exposed to the outside via an opening 10 provided in the center of the lower shell 3 as shown in Part B of FIG. 1. On the inner peripheral side of this chucking gear 9, an annular metal plate 11 magnetically attracted to the reel rotation drive shaft described above is fixed to the bottom outer surface of the lower flange 8 by insert-molding.

The tape cartridge 1 has a reel locking mechanism for preventing the tape reel 5 from rotating when the tape cartridge 1 is not in use. The reel locking mechanism includes a plurality of gear forming walls 86 erected on the upper surface of the lower flange 8, a reel lock member 13 including engagement teeth 13a that engage with a gear portion 86a formed on the upper surface of the gear forming wall 86, a reel lock release member 14 for releasing the engagement between the gear forming wall 86 and the reel lock member 13, and a reel spring 15 provided between the inner surface of the upper shell 2 and the upper surface of the reel lock member 13. The reel spring 15 is a coil spring, and biases the tape reel 5 toward the lower shell 3 via the reel lock member 13.

The plurality of gear forming walls 86 has an arc shape and is formed at intervals on the same circumference around the axial center of the reel hub 6. The engagement teeth 13a of the reel lock member 13 facing the gear portion 86a of the gear forming wall 86 are annularly formed on the lower surface of the reel lock member 13 and constantly urged in the direction of engaging with the gear portion 86a under the reel spring 15.

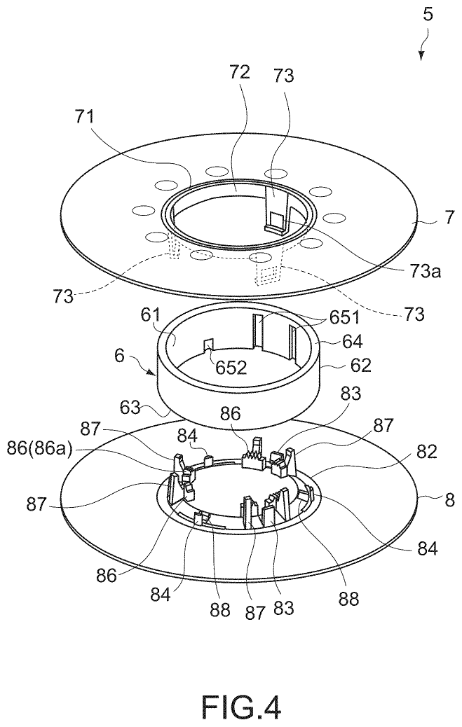

The reel lock release member 14 has a substantially triangular shape and is disposed between the lower flange 8 and the reel lock member 13. On the lower surface of the reel lock release member 14, a total of three legs 14a are formed to protrude downward from the vicinity of the apexes of the substantially triangular shape. These legs are positioned between the gears of the chucking gear 9 via an insertion hole 88 (see FIG. 4) formed in the lower flange 8 corresponding to the respective legs 14a when the cartridge is not in use.

Each of the legs 14a of the reel lock release member 14 is pressed upward by the reel rotation drive shaft of a tape drive device, which engages with the chucking gear 9, when the cartridge is in use, and causes the reel lock member 13 to move to the unlocked position against the biasing force of the reel spring 15. Further, the legs 14a are configured to be rotatable with respect to the reel lock member 13 together with the tape reel 5. A support surface 14b for supporting a sliding contact portion having a circular arc shape in cross section, which is formed to protrude at a substantially central portion of the lower surface of the reel lock member 13 is provided at a substantially central portion of the upper surface of the reel lock release member 14.

An outlet 27 for pulling out one end of the magnetic tape 22 to the outside is provided to a side wall 26 of the cartridge case 4. A slide door 29 that opens and closes the outlet 27 is disposed on the inner side of the side wall 26. The slide door 29 is configured to slide in the direction of opening the outlet 27 against the urging force of a torsion spring 57 by engaging with a tape loading mechanism (illustration omitted) of the tape drive device.

A leader pin 31 is fixed to one end of the magnetic tape 22. The leader pin 31 is configured to be attachable/detachable to/from a pin holding portion 33 provided on the inner side of the outlet 27. The pin holding portion 33 is attached to the inner surface of the upper shell 2 and the inner surface of the lower shell 3, and is configured to be capable of elastically holding the upper end and the lower end of the leader pin 31.

In addition to a safety tab 25 for preventing erroneous erasure of information recorded on the magnetic tape 22, a cartridge memory 54 capable of reading and writing the content relating to information recorded on the magnetic tape 22 in a non-contact manner is disposed inside the cartridge case 4. The cartridge memory 54 includes a non-contact communication medium in which an antenna coil, an IC chip, and the like are mounted on a substrate.

[Tape Reel]

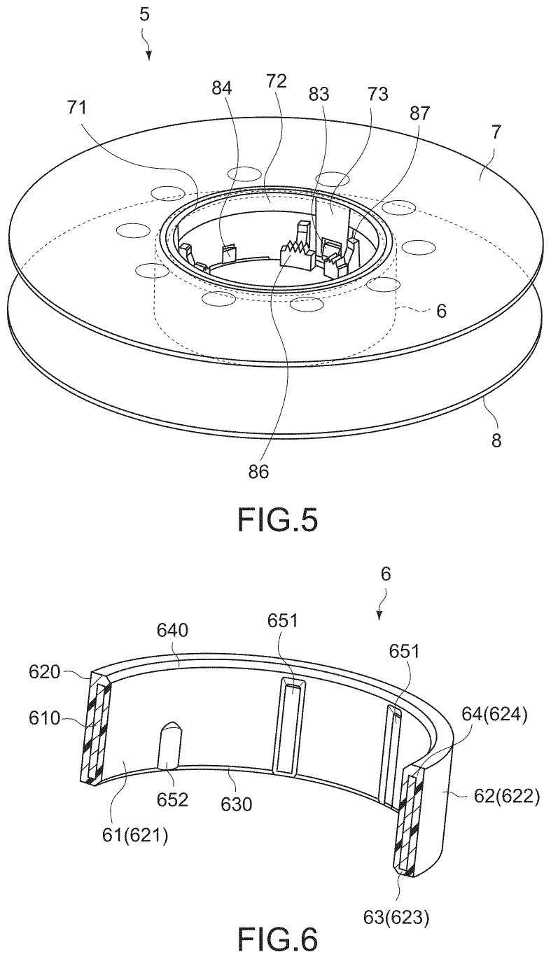

Subsequently, details of the tape reel 5 will be described. FIG. 4 is an exploded perspective view of the tape reel 5, and FIG. 5 is an entire perspective view of the tape reel.

As described above, the tape reel 5 includes the reel hub 6, the upper flange 7 (second flange), and the lower flange 8 (first flange). The reel hub 6, the upper flange 7, and the lower flange 8 are separate parts, and are combined with each other as shown in FIG. 3 and FIG. 4 to form the tape reel 5.

The reel hub 6 has a function as a winding core of the magnetic tape 22 and is disposed between the upper flange 7 and the lower flange 8. The reel hub 6 is a cylindrical member that has an inner peripheral surface 61, an outer peripheral surface 62, a lower-flange-side end surface 63 facing the lower flange 8, and an upper-flange-side end surface 64 facing the upper flange 7. The outer diameter of the reel hub 6 is 44 mm, and the axial height thereof is a slightly larger height (e.g., 12.86 mm) than the width of the magnetic tape 22 (e.g., 12.65 mm). The reel hub 6 includes an injection molded body formed of a synthetic resin material, which incorporates a metal ring obtained by insert-molding, as will be described in detail below.

The upper flange 7 has a disk shape, includes an injection molded body formed of a synthetic resin material such as PC and ABS, and is typically formed of a translucent material. The upper flange 7 includes a circular opening 71 in a central portion, and an annular protruding portion 72 that hangs down from the peripheral edge of the opening 71 toward the reel hub 6 is provided. The outer diameter of the annular protruding portion 72 is slightly smaller than the inner diameter of the reel hub 6, and the annular protruding portion 72 is caused to fit to a tapered surface 640 formed on the inner peripheral edge of the upper-flange-side end surface 64 of the reel hub 6, so that the center of the upper flange 7 is positioned on the axial center of the reel hub 6 and the upper-flange-side end surface 64 faces the lower surface of the upper flange 7 on the outer periphery side of the annular protruding portion 72 (see FIG. 3 and FIG. 6).

The upper flange 7 further includes a plurality of first engagement portions 73 that engages with the lower flange 8. The first engagement portions 73 are tongue-like plate pieces that are provided radially inward of the reel hub 6 and extend partially from the annular protruding portion 72 toward the inside of the reel hub 6. In this embodiment, the first engagement portions 73 are provided at three positions at equal angular intervals. The number of first engagement portions 73 is not limited to three and may be two or four or more.

Note that the opening 71, the annular protruding portion 72, and the plurality of first engagement portions 73 described above are simultaneously formed when the upper flange 7 is molded.

The lower flange 8 has a disk shape and includes an injection molded body formed of a synthetic resin material such as PC and ABS. The annular chucking gear 9 is provided in the central portion of the lower surface of the lower flange 8, and the metal plate 11 is fixed to the inner peripheral side of the chucking gear 9.

An annular support portion 82 that supports the lower-flange-side end surface 63 of the reel hub 6 is provided in the central portion of the upper surface of the lower flange 8, and a plurality of protruding portions 84 that engages with a plurality of engagement recessed portions 652 (second recessed portions) provided on the inner peripheral surface 61 of the reel hub 6 is provided at predetermined positions on the inner peripheral edge of the support portion 82. The protruding portions 84 regulate the relative rotation of the reel hub 6 about the axis of the lower flange 8 by engaging with the engagement recessed portions 652.

A plurality of insertion holes 88 through which the legs 14a of the reel lock release member 14 passes, the plurality of gear forming walls 86 having, on the upper surface thereof, the gear portion 86a that engages with the engagement teeth 13a of the reel lock member 13, and a plurality of guide wall portions 87 for positioning the reel lock member 13 and the reel hub 6 with respect to the lower flange 8 are provided radially inward of the support portion 82 in the lower flange 8. The reel lock member 13 is disposed on the inner peripheral side of the guide wall portions 87, and thus, the center of the reel lock member 13 is guided to the axial center position of the reel hub 6.

The reel hub 6 is disposed on the outer periphery side of the guide wall portions 87 and thus is positioned radially with respect to the lower flange 8. A tapered surface 630 for enhancing the ease of assembly to the guide wall portions 87 is formed at the inner peripheral edge of the lower-flange-side end surface 63 of the reel hub 6 (see FIG. 6). A total of three sets are disposed at equal angular intervals on the inner peripheral side of the support portion 82, one set including two gear forming walls 86 and two guide wall portions 87.

The lower flange 8 further includes a plurality of second engagement portions 83 that engages with the plurality of first engagement portions 73 of the upper flange 7. The second engagement portion 83 is a plate-like claw portion that is provided radially inward of the reel hub 6 and protrudes from the inner peripheral side of the support portion 82 toward the first engagement portion 73. The second engagement portion 83 is disposed between the set of two gear forming walls 86, and the second engagement portion 83 are provided at three positions at equal angular intervals on the inner peripheral side of the support portion 82.

The second engagement portions 83 engage with rectangular engagement holes 73a provided at the tips of the first engagement portions 73 from the outer periphery side of the first engagement portions 73 by a snap fit system (see FIG. 3). As a result, the upper flange 70 and the lower flange 80 are integrally connected to each other, and the reel hub 6 is sandwiched between the upper flange 7 and the lower flange 8.

Note that the chucking gear 9, the support portion 82, the plurality of second engagement portions 83, the plurality of engagement protrusions 84, the plurality of gear forming walls 86, the plurality of guide wall portions 87, and the plurality of insertion holes 88 are simultaneously formed when the lower flange 8 is molded.

[Reel Hub]

Subsequently, details of the reel hub 6 will be described.

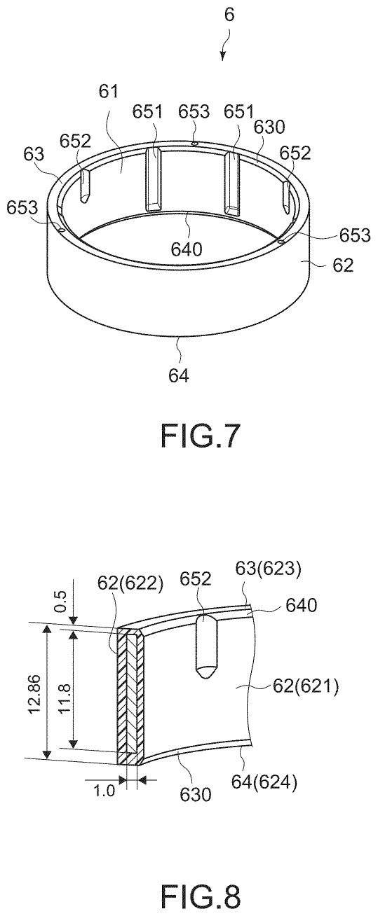

FIG. 6 is a cross-sectional perspective view of the reel hub 6. FIG. 7 is an entire perspective view of the reel hub 6 as viewed from the side of the lower-flange-side end surface 63, and FIG. 8 is a longitudinal cross-sectional view of the main portion thereof. The reel hub 6 includes a cylindrical metal ring 610 and a molded body 620 that is formed to cover the surroundings of the metal ring 610 and is formed of a synthetic resin.

The metal material forming the metal ring 610 is not particularly limited, but the metal ring 610 is formed of a non-magnetic metal material such as stainless steel (SUS304, SUS303) and an aluminum alloy in the case where it is applied to the reel hub 6 forming the winding core of the magnetic tape 22. The height of the metal ring 610 along the axial direction is, for example, approximately 11.8 mm, and the thickness thereof is, for example, approximately 1 mm (see FIG. 8).

The synthetic resin material forming the molded body 620 is not particularly limited, and is formed of a plastic material having rigidity, heat resistance, and chemical resistance such as polycarbonate (PC) and polyphenylene sulfide (PPS) in this embodiment. Further, the synthetic resin material may be a composite plastic material containing a glass filler or the like. As a result, the strength of the molded body 620 is improved and the rigidity of the reel hub 6 is enhanced. The type of the filler is not particularly limited. However, for example, by using a plate-like (flake-like) filler, it is possible to reduce the anisotropy of the molding shrinkage rate and thus improve the deterioration of the cylindrical accuracy due to welding or the like.

The molded body 620 is formed around the metal ring 610 to cover the inner peripheral surface, the outer peripheral surface, and both end surfaces of the metal ring 610 in the axial direction thereof. Specifically, the molded body 620 includes a first resin portion 621 formed on the inner peripheral surface of the metal ring 610, a second resin portion 622 formed on the outer peripheral surface of the metal ring 610, a third resin portion 623 formed on the end surface of the metal ring 610 on the side of the lower flange 8, and a fourth resin portion 624 formed on the end surface on the side of the upper flange 7 of the metal ring 610.

The first resin portion 621 is formed in a cylindrical shape along the inner peripheral surface of the metal ring 610 to form the inner peripheral surface 61 of the reel hub 6. The second resin portion 622 is formed in a cylindrical shape along the outer peripheral surface of the metal ring 610 to form the outer peripheral surface 62 of the reel hub 6. The third resin portion 623 is formed on the end surface of the metal ring 610 on the side of the lower flange 8 to form the lower-flange-side end surface 63 of the reel hub 6. The fourth resin portion 624 is formed on the end surface of the metal ring 610 on the side of the upper flange 7 to form the upper-flange-side end surface 64 of the reel hub 6.

Since the molded body 620 is formed to mold the metal ring 610, it is possible to form each surface of the reel hub 6 with desired accuracy as compared with the case where the reel hub 6 includes only the metal ring 610. In particular, since the outer peripheral surface 62 of the reel hub 6 that is in contact with the magnetic tape 22 includes the molded body 620 (second resin portion 622), it is possible to increase the cylindrical accuracy of the outer peripheral surface 62 of the reel hub 6 without requiring special processing of the outer peripheral surface of the metal ring 610.

The method of molding the molded body 620 is not particularly limited, and the respective resin portions 621 to 624 are simultaneously formed by single molding in this embodiment as will be described below. In order to achieve target molding quality, the first resin portion 621 and the second resin portion 622 are formed to have thicknesses equivalent to each other (e.g., approximately 1.2 mm). The thicknesses of the third resin portion 623 and the fourth resin portion 624 are not particularly limited. The thickness of the third resin portion 623 is approximately 0.50 mm and the thickness of the fourth resin portion 624 is approximately 0.56 mm.

(First Recessed Portion)

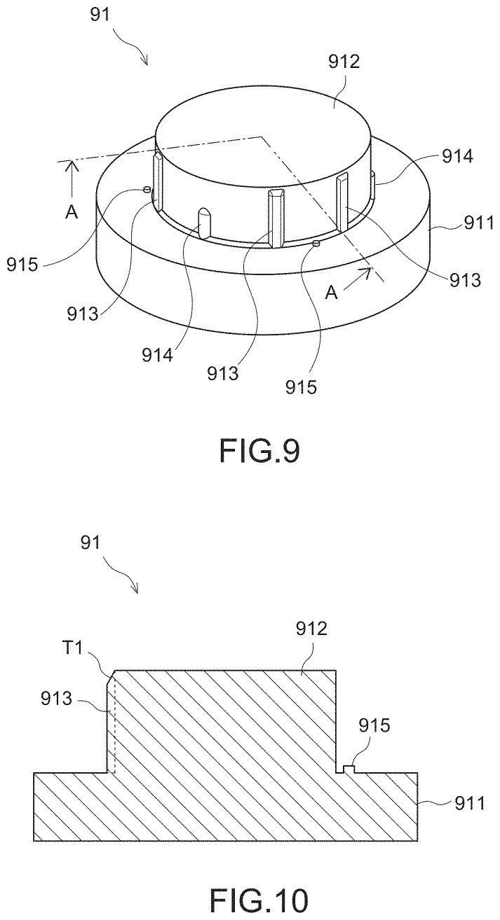

The first resin portion 621 includes a plurality of positioning recessed portions 651 (first recessed portions) formed at intervals in a circumferential direction of the metal ring 610 (reel hub 6). Each of the plurality of positioning recessed portions 651 is a recessed portion formed in the inner peripheral surface 61 of the reel hub 6 by a plurality of ridges 913 (see FIG. 9) formed on the surface of the mold facing the inner peripheral surface of the metal ring 610 when insert-molding the metal ring 610.

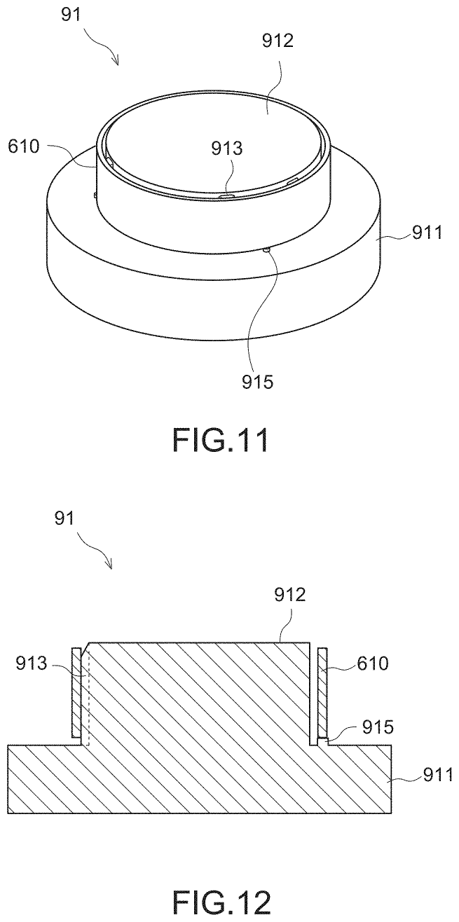

FIG. 9 is an entire perspective view showing a first mold 91 for molding the reel hub 6. FIG. 10 is a cross-sectional view taken along the line A-A in FIG. 9, FIG. 11 is an entire perspective view of the first mold 91 in which the metal ring 610 is set, and FIG. 12 is a cross-sectional view of FIG. 11, which corresponds to FIG. 10.

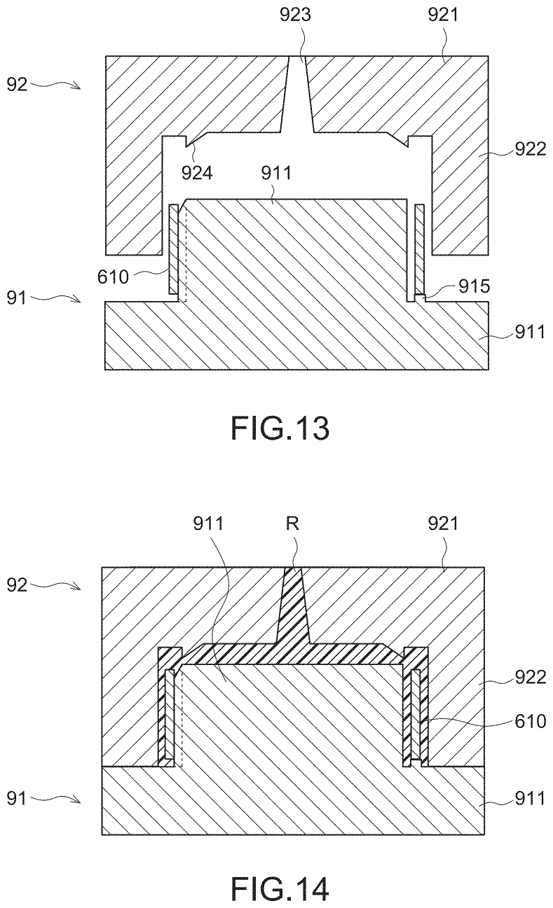

The first mold 91 is configured as a movable mold and is configured to be capable of moving with respect to a second mold 92 as a fixed mold described below (see FIG. 13). The first mold 91 has a stepped columnar shape including a base portion 911 (first base portion) and a core portion 912 integrally formed with the base portion 911.

The base portion 911 has an outer diameter larger than the outer diameter of the metal ring 610. The core portion 912 is formed concentrically with the base portion 911. The core portion 912 is a columnar portion that has an outer diameter smaller than the inner diameter of the metal ring 610 and faces the inner peripheral surface of the metal ring 610. The height of the core portion 912 is slightly lower than the height of the metal ring 610, and the upper surface of the core portion 912 lies slightly below the upper end of the metal ring 610 when the core portion 912 is inserted into the inside of the metal ring 610.

Each of the plurality of ridges 913 described above is provided at a predetermined position of the outer peripheral surface of the core portion 912. The plurality of ridges 913 extends along the axial direction of the metal ring 610 and protrudes from the outer peripheral surface of the core portion 912 toward the inner peripheral surface of the metal ring 610. Each of the ridges 913 is for positioning the metal ring 610 radially with respect to the core portion 912. Therefore, it is favorable that each of the ridges 913 is provided on the peripheral surface of the core portion 912 with the protruding amount capable of abutting on the inner peripheral surface of the metal ring 610. As shown in FIG. 10, the lower end of each of the ridges 913 is in contact with the upper surface of the base portion 911, and a tapered portion T1 for enhancing the ease of attachment of the metal ring 610 to the core portion 912 is provided at the upper end of each of the ridges 913.

The plurality of positioning recessed portions 651 provided on the inner peripheral surface of the reel hub 6 is formed in a shape corresponding to the respective ridges 913 at a position corresponding to the respective ridges 913. In this embodiment, a total of three sets of a pair of the positioning recessed portions 651 (total six) are provided at equal angular intervals on the inner peripheral surface of the reel hub 6. The number of positioning recessed portions 651 is not limited thereto and only needs to be at least three or more.

The positioning recessed portion 651 is a groove portion that extends in the axial direction of the metal ring 610. The shape of the groove portion is not particularly limited. Although the shape of the groove portion is a square groove in this embodiment, it may be another shape such as a V-shaped groove and a U-shaped groove in addition thereto. The inner peripheral surface of the metal ring 610 may be partially exposed from the bottom portion of the positioning recessed portion 651.

Further, the positioning recessed portion 651 is formed from one end (lower-flange-side end surface 63) of the first resin portion 621 in the axial direction to a the vicinity of the other end (upper-flange-side end surface 64) of the first resin portion 621 in the axial direction. Since the positioning recessed portion 651 extends to the one end of the first resin portion 621, the reel hub 6 can be easily separated from the core portion 912 after molding the reel hub 6.

(Second Recessed Portion)

The first resin portion 621 further includes the plurality of engagement recessed portions 652 (second recessed portions) formed at intervals in the circumferential direction of the metal ring 610 (reel hub 6). The plurality of engagement recessed portions 652 engages with the plurality of engagement protrusions 84 formed in the lower flange 8 to position the reel hub 6 with respect to the lower flange 8.

The plurality of engagement recessed portions 652 is formed by a plurality of projecting portions 914 (see FIG. 9) provided on the outer peripheral surface of the core portion 912 of the first mold 91. Each of the projecting portions 914 extends along the axial direction of the core portion 912 from the upper surface of the base portion 911 and protrudes from the outer peripheral surface of the core portion 912 toward the inner peripheral surface of the metal ring 610. The protruding amount of each of the projecting portions 914 is not particularly limited and is equal to or smaller than the protruding amount of the ridge 913.

The plurality of engagement recessed portions 652 is formed in a shape corresponding to the respective projecting portions 914 at a position corresponding to the respective projecting portions 914. In this embodiment, a total of three engagement recessed portions 652 are provided at equal angular intervals between the respective sets of a pair of the positioning recessed portions 651. The number of engagement recessed portions 652 is not limited thereto and only needs to be at least three or more. Also the height of each of the engagement recessed portions 652 (length along the axial direction of the metal ring 610) is not particularly limited and only needs to be higher than the engagement protrusion 84 of the lower flange 8. In this embodiment, the engagement recessed portion 652 is formed from the end portion of the core portion 912 on the side of the base portion 911 to a vicinity of the center of the core portion 912 in the height direction.

(Hole)

As shown in FIG. 7, the third resin portion 623 forming the lower-flange-side end surface 63 of the reel hub 6 includes a plurality of holes 653. The plurality of holes 653 is formed at intervals in the circumferential direction of the metal ring 610 (reel hub 6). In this embodiment, the plurality of holes 653 is formed at equal angular intervals in the third resin portion 623.

The plurality of holes 653 is formed by a plurality of protruding portions 915 (see FIG. 9) provided on the upper surface of the base portion 911 of the first mold 91. Each of the protruding portions 915 protrudes from the upper surface of the base portion 911 along the surroundings of the core portion 912 toward the lower surface of the metal ring 610 (see FIG. 11 and FIG. 12). The plurality of protruding portions 915 supports the lower surface of the metal ring 610 inserted into the core portion 912 at many points to form a predetermined gap between the lower surface of the metal ring 610 and the upper surface of the base portion 611. The predetermined gap corresponds to the thickness of the third resin portion 623.

The plurality of holes 653 is formed in a shape corresponding to the respective protruding portions 915 at a position corresponding to the respective protruding portions 915. In this embodiment, a total of three holes 653 are formed at equal angular intervals between the corresponding set of a pair of the positioning recessed portions 651. The number of holes 653 is not limited thereto and only needs to be at least three or more. The end surface of the metal ring 610 may be partially exposed from the bottom portion of the hole 653.

(Method of Producing Reel Hub)

Subsequently, a method of molding the reel hub 6 configured as described above will be described with reference to FIG. 11 to FIG. 14. FIG. 13 and FIG. 14 are each a schematic diagram describing a method of molding the reel hub 6. In this embodiment, a molding method by a film gate system will be described as an example.

First, the metal ring 610 is inserted into the core portion 912 (see FIG. 11 and FIG. 12) such that the inner peripheral surface of the metal ring 610 faces the core portion 912 of the first mold 91. At this time, the metal ring 610 is concentrically disposed with respect to the core portion 912 by the plurality of ridges 913 formed on the outer peripheral surface of the core portion 912. Further, a gap for forming the first resin portion 621 is formed between the outer peripheral surface of the core portion 912 and the inner peripheral surface of the metal ring 610.

Meanwhile, the lower end of the metal ring 610 is supported by the plurality of protruding portions 915 formed on the upper surface of the base portion 911. As a result, the upper surface of the base portion 911 faces the lower end of the metal ring 610 via a predetermined gap.

Subsequently, as shown in FIG. 13 and FIG. 14, the first mold 91 is combined with the second mold 92. The second mold 92 includes a base portion 921 (second base portion) and a cylindrical portion 922 integrally formed with the base portion 921.

The cylindrical portion 922 is concentrically combined with the core portion 912 to face the outer peripheral surface of the metal ring 610 via a gap for forming the second resin portion 622. The base portion 921 includes a resin injection port 923 (see FIG. 13) and is formed to be capable of forming, between the upper end of the metal ring 610 and the upper surface of the core portion 912 of the first mold 91, an outflow path for causing a resin to flow out from the resin injection port 923 toward the outer peripheral surface of the core portion 912 and the inner peripheral surface of the cylindrical portion 922. As shown in FIG. 14, the first mold 91 and the second mold 92 are combined with each other by bringing the upper surface of the base portion 911 into close contact with the entire circumference of the lower end of the cylindrical portion 922. At this time, the outflow path forms part of a cavity formed between the first mold 91 and the second mold 92.

Subsequently, as shown in FIG. 14, a paste-like synthetic resin material R is injected into the cavity via the resin injection port 923, thereby forming the molded body 620 that covers the surroundings of the metal ring 610. The synthetic resin material R flows between the outer peripheral surface of the core portion 912 and the inner peripheral surface of the cylindrical portion 922 to cover the inner peripheral surface, the outer peripheral surface, and both end surfaces of the metal ring 610 in the axial direction thereof. An annular raised portion 924 that protrudes toward the peripheral edge of the upper surface of the core portion 912 is provided in the base portion 921 of the second mold 92. The raised portion 924 locally narrows part of the outflow path for causing the synthetic resin material R to flow from the resin injection port 923 toward the outer periphery side of the core portion 912. As a result, the resin injection port 923 is formed over the entire circumference of the upper end (end on the side of the upper flange 7) of the metal ring 610, and the synthetic resin material R can be injected uniformly over the entire circumference between the outer peripheral surface of the core portion 912 and the inner peripheral surface of the cylindrical portion 922.

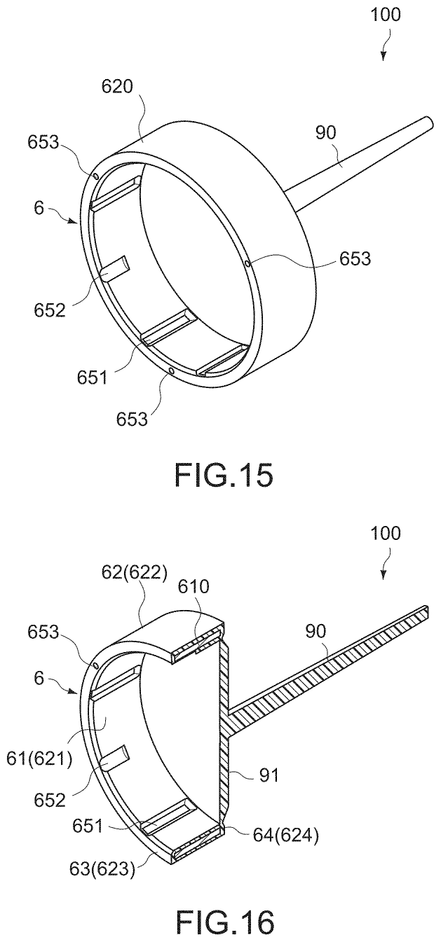

After cooling the injected synthetic resin material R, the first mold 91 and the second mold 92 are separated from each other and an insert-molded body of the metal ring 610 is extracted from the first mold 91. FIG. 15 is an entire perspective view of an insert-molded body 100 and FIG. 16 is a longitudinal cross-sectional view thereof.

As shown in FIG. 15 and FIG. 16, the insert-molded body 100 has a structure in which the reel hub 6 and a runner portion 90 are integrated. The runner portion 90 is separated from the reel hub 6 by cutting the peripheral edge of a disk portion 91 thereof. In this case, a gate mark that is a resin injection path is formed over the entire circumference of the inner peripheral edge of the upper-flange-side end surface 64 of the reel hub 6.

### Effects of this Embodiment

As described above, in accordance with this embodiment, it is possible to mold the reel hub 6 in which the surroundings of the metal ring 610 are covered by the molded body 620 in a single molding process. As a result, it is possible to achieve a reduction in the production cost and an improvement in the productivity of the reel hub 6 and the tape reel 5 that includes the reel hub 6.

Further, since the inner peripheral surface of the metal ring 610 is supported by the plurality of ridges 913 formed on the outer peripheral surface of the first mold 91 when producing the reel hub 6, the metal ring 610 can be disposed concentrically with respect to the columnar core portion 912 and the metal ring 610 can be positioned with respect to the first mold 91 with high accuracy. As a result, it is possible to prevent the metal ring 610 from being displaced with respect to the first mold 91 due to the injection pressure of the synthetic resin material R and thus uniformly form the first resin portion 621 and the second resin portion 622 that respectively cover the inner peripheral surface and the outer peripheral surface of the metal ring 610 over the entire circumference.

In particular, since a total of three sets are provided at equal angular intervals in the circumferential direction of the metal ring 610, one set including a pair of the ridges 913, it is possible to prevent sink marks from occurring in the first resin portion 621 formed on the inner peripheral surface of the reel hub 6. As a result, it is possible to make the thickness of the first resin portion 621 in a region other than the positioning recessed portion 651 uniform.

Further, in the tape reel 5 that includes the reel hub 6 configured as described above, since the reel hub 6 includes an insert-molded body of the metal ring 610, for example, the rigidity of the reel hub 6 can be enhanced as compared with the case where the lower flange and the reel hub include an integrated molded body of a synthetic resin material. As a result, the fluctuation in the width of the magnetic tape wound around the reel hub can be suppressed and stable recording and reproduction accuracy can be achieved even in a tape region near the reel hub.

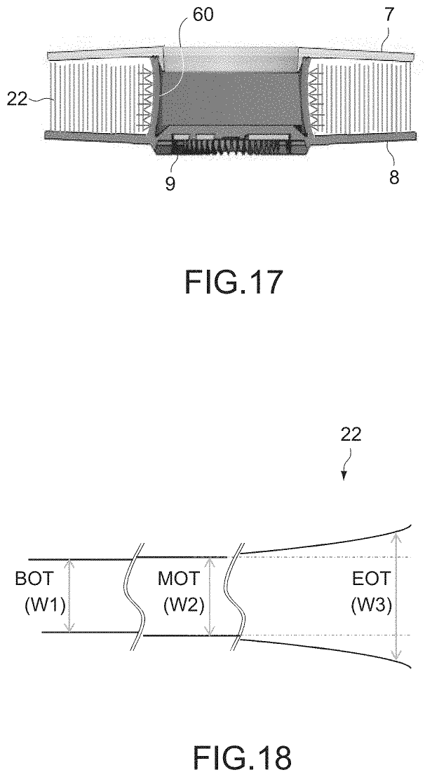

In particular, in recent years, the thinning of the magnetic tape 22 and the increase in the tape length have been promoted in accordance with the increase in the recording capacity of the tape cartridge. Meanwhile, the tightening of the magnetic tape causes a problem that the reel hub deforms radially inward. For example, as shown in FIG. 17, in the case of a reel hub 60 that is formed of a synthetic resin and integrally formed with the lower flange 8, the amount of deformation increases to the extent that the reel hub 60 is curved in a direction of projecting radially inward in some cases as shown somewhat exaggerated in the figure. In this case, since stress in the tape width direction acts also on the magnetic tape 22, changes in the width dimension of the magnetic tape 22 are problematic. Further, in the case where the preservation environment of the tape cartridge is high temperature and high humidity, there has been a possibility that the width dimension of the magnetic tape wound in the vicinity of the reel hub is partially changed as the reel hub is deformed.

FIG. 18 is a schematic diagram describing a change in the width dimension of a magnetic tape due to deformation of a reel hub. As shown in FIG. 18, the width dimension of the magnetic tape wound around the tape reel in which deformation has occurred in the reel hub differs in the respective regions of BOT (Begin of Tape), MOT (Middle of Tape), and EOT (End of Tape). The BOT refers to the region on the outer peripheral side near the end of the tape to which a leader pin is attached, the EOT refers to the region on the inner peripheral side near the reel hub, and the MOT refers to the region between the EOT and BOT. In the case where the average values of the tape widths of the BOT, MOT, and EOT regions are defined as W1, W2, and W3, respectively, since the fluctuation amount (widening amount) of the tape width dimension on the inner peripheral side, which is likely to be affected by deformation of the reel hub, is larger, typically, the size of the tape width in the respective regions satisfies the relationship of W1<W2<W3. Then, when the widening amount of the magnetic tape becomes too large, there is a possibility that the recording/reproduction characteristics of the magnetic tape is adversely affected.

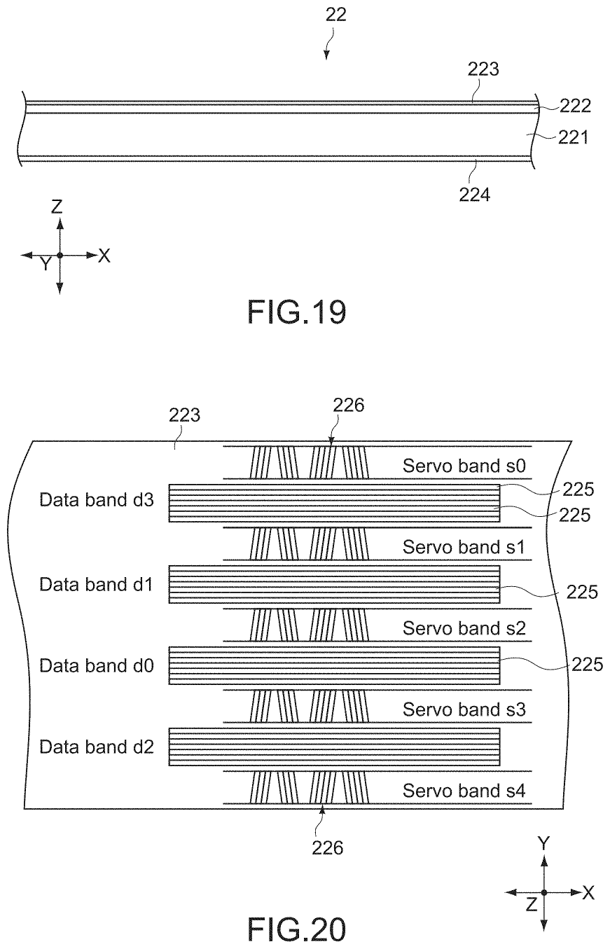

Here, as shown in FIG. 19, the magnetic tape 22 includes a tape-shaped base material 221 long in the longitudinal direction (X-axis direction), a non-magnetic layer 222 provided on one main surface of the base material 221, a magnetic layer 223 provided on the non-magnetic layer 222, and a back layer 224 provided on the other main surface of the base material 221. Note that the back layer 224 only needs to be provided as necessary and may be omitted.

FIG. 20 is a schematic diagram of the magnetic tape 22 as viewed from above. Referring to FIG. 20, the magnetic layer 223 includes a plurality of data bands d (data bands d0 to d3) that is long in the longitudinal direction (X-axis direction), a data signal being written to the plurality of data bands d, and a plurality of servo bands s (servo bands s0 to s4) long in the longitudinal direction, a servo signal being written to the plurality of servo bands s. The servo bands s are located at positions where the respective data bands d are sandwiched in the width direction (Y axis direction). Since the servo bands s are located at positions where the respective data bands d are sandwiched, the number of servo bands s is one more than the number of data bands d. In the example shown in FIG. 20, a case where the number of data bands d is four and the number of servo bands s is five is shown. Note that the number of data bands d and the number of servo bands s can be changed as appropriately.

The data band d includes a plurality of recording tracks 225 that is long in the longitudinal direction and aligned in the width direction. A data signal is recorded along this recording track 225 in the recording track 225. The servo band s includes a servo signal recording pattern 226 of a predetermined pattern, a servo signal being recorded on the servo signal recording pattern 226 by a servo signal recording device (not shown).

In the magnetic tape 22 configured as described above, since data bands on which data signals are recorded are aligned in the tape width direction, there is a possibility that the expansion of the tape width causes the distance between adjacent data bands d to fluctuate and stable recording/reproduction cannot be performed.

In this regard, in this embodiment, in order to suppress the deformation of the reel hub 6 due to the tightening of the magnetic tape 22, the reel hub 6 includes an insert-molded body of the metal ring 610. For this reason, the rigidity of the reel hub 6 is enhanced and it is possible to suppress the deformation due to the winding pressure of the magnetic tape 22 or the preservation environment of the tape cartridge 1 as compared with the case where the reel hub is formed of a plastic material integrally formed with the lower flange. As a result, since the fluctuation in the width of the EOT region of the magnetic tape 22 particularly is suppressed, stable recording and reproduction can be performed.

### EXAMPLES OF EXPERIMENT

Hereinafter, examples of experiments conducted by the present inventors will be described.

### Example 1

By insert-molding a metal ring that has a thickness of 1 mm and is formed of SUS304 with a composite resin material containing 65 wt % of an inorganic filler (a glass filler and a mineral filler) in PPS, a reel hub having an outer diameter of 44 mm±0.1 mm, an inner diameter of 38.85 mm±0.1 mm, and a height of 12.86 mm±0.1 mm was prepared.

<<Hub Rigidity Evaluation>>

Subsequently, the prepared reel hub was subjected to a compressive test to evaluate the rigidity. A compression tester “RTG-1210” manufactured by A & D Co., Ltd. was used as the compression tester.

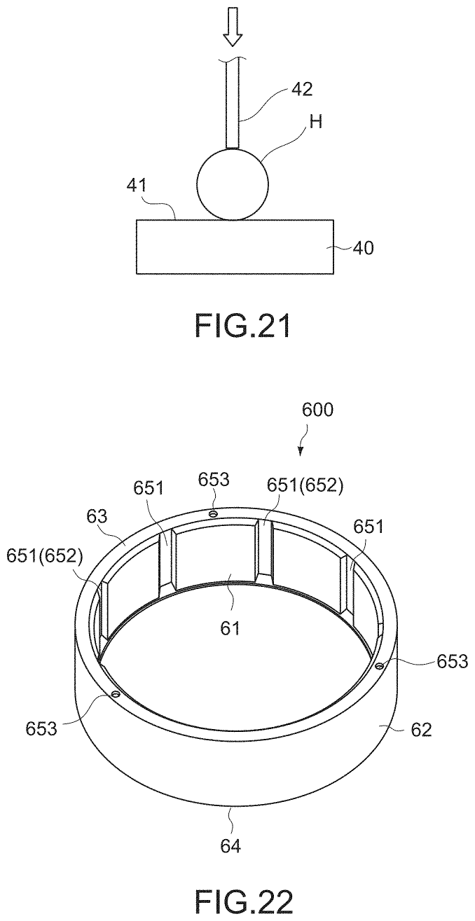

As shown in FIG. 21, a columnar probe 42 having a diameter of 10 mm was attached to the load cell (1 kN) of the tester, and a jig 40 including a flat receiving portion 41 was installed on the pedestal of the tester. While the lower outer peripheral surface of a reel hub H was supported by the receiving portion 41, the distal end portion of the probe 42 was caused to be in contact with the upper end outer peripheral surface of the reel hub H, and the amount of deformation radially inward of the outer periphery portion was measured by applying a weight of a predetermined magnitude to the reel hub H radially inward (vertically downward).

The test velocity was 2 mm/min, and the sampling interval was 5 μm. The amount of deformation at 100 N and 150 N was used as a measurement value.

<<Measurement of Tape-Width Change>>

A tape reel shown in FIG. 5 was prepared by attaching an upper flange and a lower flange to the prepared reel hab. In this tape reel, a magnetic tape having a width of 12.65 mm, an overall length of 960 m, and a total thickness of 5.6 μm was wrapped around a reel hub with a tension of 0.64 N to prepare a tape-wound body. Before and after the obtained tape-wound body was preserved in an environment of temperature of 49° C. and humidity of 80% for one week, the deviation amount of the track position of the tape in each region of the BOT, MOT, and EOT was measured by the LTO drive.

Here, the tape lengths of the BOT, MOT and EOT regions were respectively in the range of 25 m to 85 m, 425 m to 485 m, and 885 m to 945 m when the tape tip was defined as 0 [m]. The deviation amount of the track position was calculated from the difference between each data band size measured from the tracking control amount during reproduction of the data signals recorded on the data bands d0 and d3 (see FIG. 20) and the Nominal value (LTO7) thereof, and the value obtained by measuring this for each of the BOT, MOT, and EOT regions was used as the tape width change amount.

### Comparative Example 1

A reel hub was prepared by an injection molding method using a composite resin material containing 65 wt % of an inorganic filler (a glass filler and a mineral filler) in PPS. The reel hub had an outer diameter of 44 mm±0.1 mm, an inner diameter of 38.85 mm±0.1 mm, and a height of 12.86 mm±0.1 mm.

The rigidity of this reel hub was measured by a method similar to that in Example 1. An upper flange and a lower flange were attached to the prepared reel hub to prepare a tape reel. A magnetic tape having a width of 12.65 mm, a total length of 960 m, and a total thickness of 5.6 μm was wound around the reel hub in this tape reel at a tension of 0.64 N to prepare a tape-wound body. The deviation amount of the track position of the tape in each of the BOT, MOT, and EOT regions was measured by a method similar to that in Experimental Example 1 before and after preserving the obtained tape-wound body for one week in an environment of a temperature of 49° C. and a humidity of 80%.

The constituent material and the hub rigidity of the reel hub according to each of the Example 1 and the Comparative Example 1 and the results of evaluating the tape-width change are shown in Table 1. In Table 1, “+” and “−” in the tape-width change respectively indicate an increase in the width and a decrease in the width.

TABLE 1

| | | Hub rigidity | | | | |
|---|---|---|---|---|---|---|
| | | When 100N | When 150N | Tape width change amount | | |
| | | is applied | is applied | BOT | MOT | EOT |
| | Material | (mm) | (mm) | (μm) | (μm) | (μm) |
| Example 1 | PPS + GF/MF | 0.425 | 0.675 | −2.8 | 0.6 | 5.1 |
| | (With metal ring) | | | | | |
| Comparative | PPS + GF/MF | 0.515 | 0.775 | −1.7 | 1.5 | 6.1 |
| Example 1 | (Without metal ring) | | | | | |

As shown in Table 1, in accordance with the Example 1, it was confirmed that the deformation amounts when weights of 100 N and 150 N were applied radially inward to the central portion of the outer periphery portion of the reel hub in the axial direction were smaller than those in the Comparative Example 1. As a result, it was also confirmed that the deformation of the reel hub due to the tightening (winding pressure) of the magnetic tape could be made smaller than that in the Comparative Example 1 and particularly, the fluctuation in the tape width in the EOT region could be made smaller than that in the Comparative Example 1.

### Example 2

By insert-molding a metal ring that has a thickness of 1 mm and is formed of SUS304 with a composite resin material containing 50 wt % of an inorganic filler (glass filler) in PC, a reel hub having an outer diameter of 44 mm±0.1 mm, an inner diameter of 38.85 mm±0.1 mm, and a height of 12.86 mm±0.1 mm was prepared. The rigidity of the reel hub and the width change amount of the magnetic tape were measured in a way similar to that in the Example 1.

### Comparative Example 2

A reel hub was prepared by an injection molding method using a composite resin material containing 50 wt % of an inorganic filler (glass filler) in PC. The reel hub had an outer diameter of 44 mm±0.1 mm, an inner diameter of 38.85 mm±0.1 mm, and a height of 12.86 mm±0.1 mm. The rigidity of the reel hub and the width change amount of the magnetic tape were measured in a way similar to that in the Comparative Example 1.

The constituent material and the hub rigidity of the reel hub according to each of the Example 2 and the Comparative Example 2 and the results of evaluating the tape-width change are shown in Table 1. In Table 1, “+” and “−” in the tape-width change respectively indicate an increase in the width and a decrease in the width.

TABLE 2

| | | Hub rigidity | | | | |
|---|---|---|---|---|---|---|
| | | When 100N | When 150N | Tape width change amount | | |
| | | is applied | is applied | BOT | MOT | EOT |
| | Material | (mm) | (mm) | (μm) | (μm) | (μm) |
| Example 2 | PC + GF | 0.530 | 0.835 | −2.8 | 0.6 | 5.1 |
| | (With metal ring) | | | | | |
| Comparative | PC + GF | 1.055 | 1.575 | −2.3 | 1.5 | 7.2 |
| Example 2 | (Without metal ring) | | | | | |

As shown in Table 2, in accordance with the Example 2, it was confirmed that the deformation amounts when weights of 100 N and 150 N were applied radially inward to the central portion of the outer periphery portion of the reel hub in the axial direction were smaller than those in the Comparative Example 2. As a result, it was also confirmed that the deformation of the reel hub due to the tightening (winding pressure) of the magnetic tape could be made smaller than that in the Comparative Example 2 and particularly, the fluctuation in the tape width in the EOT region could be made smaller than that in the Comparative Example 1.

### OTHER EMBODIMENTS

Although the positioning recessed portion 651 (first recessed portion) and the engagement recessed portion 652 (second recessed portion) formed on the inner peripheral surface 6 of the reel hub 6 are separate recessed portions in the embodiment described above, the present technology is not limited thereto. For example, as in a reel hub 600 shown in FIG. 22, the engagement recessed portion 652 may include a groove portion common to the positioning recessed portion 651. By forming the positioning recessed portion 651 and the engagement recessed portion 652 as a groove portion having the same shape in this way, the isotropy of the resin portion forming the inner peripheral surface of the reel hub 600 is enhanced and the uniformity of the resin portion can be improved.

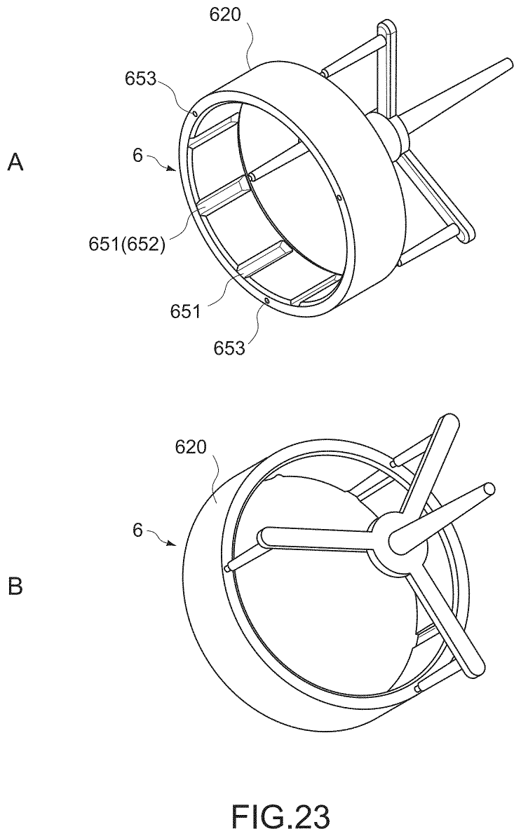

Further, although the reel hub 6 is molded by a film gate system in the embodiment described above, for example, the reel hub 6 may be molded by a pin-point gate system as shown in Parts A and B of FIG. 23.

Further, although the magnetic tape cartridge incorporating the tape reel on which the magnetic tape is wound has been described in the embodiment described above, the present technology is also applicable to a tape reel on which a cleaning tape is wound and a cleaning tape cartridge incorporating this tape reel, similarly.

Further, although the tape cartridge conforming to the LTO standard has been described in the embodiment described above, the present technology is not limited thereto and is also applicable to a tape reel in a tape cartridge of another standard, similarly.

<Details of Magnetic Tape>

As described above, the magnetic tape 22 includes the tape-shaped base material 221 long in the longitudinal direction (X-axis direction), the non-magnetic layer 222 provided on one main surface of the base material 221, the magnetic layer 223 provided on the non-magnetic layer 222, and the back layer 224 provided on the other main surface of the base material 221 (see FIG. 7). Hereinafter, details of the respective portions will be described (reference symbols will be omitted).

[Base Material]

The base material has a long film-like shape. The upper limit value of the average thickness of the base material is favorably 4.2 μm or less, more favorably 3.8 μm or less, and still more favorably 3.4 μm or less. In the case where the upper limit value of the average thickness of the base material is 4.2 μm or less, the recording capacity in one tape cartridge can be made higher than that in a general magnetic recording medium.

The average thickness of the base material is obtained as follows. First, a magnetic recording medium having a ½ inch width is prepared, and cut into a length of 250 mm to prepare a sample. Subsequently, layers other than the base material of the sample (i.e., the non-magnetic layer, the magnetic layer, and the back layer) are removed with a solvent such as MEK (methyl ethyl ketone) and dilute hydrochloric acid. Next, using a laser hologage manufactured by Mitutoyo as a measuring device, the thickness of the sample (base material) is measured at five or more points, and the measured values are simply averaged (arithmetically averaged) to calculate the average thickness of the base material. Note that the measurement positions are randomly selected from the sample.

The base material contains, for example, at least one of polyesters, polyolefins, cellulose derivatives, vinyl resins, and different polymer resins. In the case where the base material contains two or more of the above-mentioned materials, the two or more materials may be mixed, copolymerized, or laminated.

The polyesters include, for example, at least one of PET (polyethylene terephthalate), PEN (polyethylene naphthalate), PBT (polybutylene terephthalate), PBN (polybutylene naphthalate), PCT (polycyclohexylene dimethylene terephthalate), PEB (polyethylene-p-oxybenzoate), or polyethylene bisphenoxycarboxylate.

The polyolefins include, for example, at least one of PE (polyethylene) or PP (polypropylene). The cellulose derivatives include, for example, at least one of cellulose diacetate, cellulose triacetate, CAB (cellulose acetate butyrate), or CAP (cellulose acetate propionate). The vinyl resins include, for example, at least one of PVC (polyvinyl chloride) or PVDC (polyvinylidene chloride).

The different polymer resins include, for example, at least one of PA (polyamide, nylon), aromatic PA (aromatic polyamide, aramid), PI (polyimide), aromatic PI (aromatic polyimide), PAI (polyamideimide), aromatic PAI (aromatic polyamideimide), PBO (polybenzoxazole, e.g., Zylon (registered trademark)), polyether, PEK (polyetherketone), polyetherester, PES (polyethersulfone), PEI (polyetherimide), PSF (polysulfone), PPS (polyphenylene sulfide), PC (polycarbonate), PAR (polyarylate), or PU (polyurethane).

[Magnetic Layer]

A magnetic layer is a recording layer for recording a data signal. The magnetic layer contains a magnetic powder, a binder, conductive particles, and the like. The magnetic layer may further contain an additive such as a lubricant, an abrasive, and a rust inhibitor, as necessary. The magnetic layer has a surface in which a large number of holes are provided. The lubricant is stored in the large number of holes. It is favorable that the large number of holes extend in the direction perpendicular to the surface of magnetic layer.

The degree of perpendicular orientation of the magnetic layer (no demagnetizing field correction: the same applies hereinafter) may be, for example, 65% or more. Further, the degree of longitudinal orientation of the magnetic layer is 35% or less. The thickness of the magnetic layer is typically nm or more and 90 nm or less. As described above, by setting the thickness of the magnetic layer to 35 nm or more and 90 nm or less, the electromagnetic conversion characteristics can be improved.

The thickness of the magnetic layer can be obtained, for example, in the following manner. First, a test piece is prepared by processing a magnetic recording medium thinly perpendicular to the main surface thereof, and the cross section of the test piece is observed by a transmission electron microscope (TEM) under the following conditions.

Device: TEM (H9000NAR manufactured by Hitachi, Ltd.)

Acceleration voltage: 300 kV

Magnification: 100,000 times

Next, after measuring the thickness of the magnetic layer at least 10 points in the longitudinal direction of the magnetic recording medium using the obtained TEM image, these measured values are simply averaged (arithmetically averaged) to obtain the thickness of the magnetic layer. Note that the measurement positions are randomly selected from the sample piece.

(Magnetic Powder)

The magnetic powder contains a powder of nanoparticles containing ε-iron oxide (hereinafter, referred to as “ε-iron oxide particles”). The ε-iron oxide particles are capable of achieving a high coercive force even if the ε-iron oxide particles are fine particles. It is favorable that the ε-iron oxide contained in the ε-iron oxide particles is preferentially crystallographically oriented in the thickness direction (perpendicular direction) of the magnetic recording medium.

The ε-iron oxide particles each have a spherical shape or substantially spherical shape, or a cubic shape or substantially cubic shape. Since the s-iron oxide particles have the shapes described above, in the case where the ε-iron oxide particles are used as magnetic particles, the area of contact between the particles in the thickness direction of the magnetic recording medium can be reduced and aggregation of the particles can be suppressed as compared with the case of using hexagonal plate-shaped barium ferrite particles as the magnetic particles. Therefore, it is possible to increase the dispersibility of the magnetic powder and achieve a more favorable SNR (Signal-to-Noise Ratio).

The ε-iron oxide particles each have a core-shell structure. Specifically, the ε-iron oxide particles each include a core portion, and a shell portion that has a two-layer structure and is provided around the core portion. The shell portion having a two-layer structure includes a first shell portion provided on the core portion and a second shell portion provided on the first shell portion.

The core portion contains ε-iron oxide. The ε-iron oxide contained in the core portion favorably has ε-Fe₂O₃ crystal as the main phase and has more favorably a single phase of ε-Fe₂O₃.

The first shell portion covers at least a part of the periphery of the core portion. Specifically, the first shell portion may partially cover the periphery of the core portion or may cover the entire periphery of the core portion. From the viewpoint of making exchange coupling of the core portion and the first shell portion sufficient and improving the magnetic properties, the first shell portion favorably covers the entire surface of the core portion 21.

The first shell portion is a so-called soft magnetic layer, and contains, for example, a soft magnetic material such as α-Fe, a Ni—Fe alloy, and a Fe—Si—Al alloy·α-Fe may be obtained by reducing the ε-iron oxide contained in the core portion 21.

The second shell portion is an oxide coating film as an oxidation prevention layer. The second shell portion contains α-iron oxide, aluminum oxide, or silicon oxide. The α-iron oxide includes, for example, at least one iron oxide selected from the group consisting of Fe₃O₄, Fe₂O₃ and FeO. In the case where the first shell portion contains α-Fe (soft magnetic material), the α-iron oxide may be one obtained by oxidizing α-Fe contained in the first shell portion 22a.

Since the ε-iron oxide particles each include the first shell portion as described above, a coercive force Hc of the ε-iron oxide particles (core-shell particles) as a whole can be adjusted to the coercive force Hc suitable for recording while keeping the coercive force Hc of the core portion alone at a large value in order to achieve high thermal stability. Further, since the ε-iron oxide particles each include the second shell portion as described above, the ε-iron oxide particles are exposed to air and rust or the like is generated on the surfaces of the particles during and before the process of producing the magnetic recording medium, thereby making it possible to suppress the deterioration of the characteristics of the ε-iron oxide particles. Therefore, it is possible to suppress the characteristic deterioration of the magnetic recording medium.

The average particle size (average maximum particle size) of the magnetic powder is favorably 22 nm or less, more favorably 8 nm or more and 22 nm or less, and still more favorably 12 nm or more and 22 nm or less.

The average aspect ratio of the magnetic powder is favorably 1 or more and 2.5 or less, more favorably 1 or more and 2.1 or less, and still more favorably 1 or more and 1.8 or less. When the average aspect ratio of the magnetic powder is within the range of 1 or more and 2.5 or less, aggregation of the magnetic powder can be suppressed, and the resistance applied to the magnetic powder when the magnetic powder is perpendicularly oriented in the process of forming the magnetic layer can be suppressed. Therefore, the perpendicular orientation of the magnetic powder can be improved.

The average volume (particle volume) Vave of the magnetic powder is favorably 2,300 nm³ or less, more favorably 2,200 nm³ or less, more favorably 2,100 nm³ or less, more favorably 1,950 nm³ or less, more favorably 1,600 nm³ or less, and still more favorably 1,300 nm³ or less. When the average volume Vave of the magnetic powder is 2,300 nm³ or less, the peak of the reproduced waveform of the servo signal can be sharpened by narrowing the full width at half maximum of the isolated waveform in the reproduced waveform of the servo signal (to 195 nm or less). Since this improves the accuracy of reading the servo signal, the number of recording tracks can be increased to improve the recording density of data. Note that the smaller the average volume Vave of the magnetic powder, the better. Thus, the lower limit value of the volume is not particularly limited. However, for example, the lower limit value is 1,000 nm³ or more.

The average particle size, the average aspect ratio, and the average volume Vave of the magnetic powder described above are obtained as follows (e.g., in the case where the magnetic powder has a shape such as a spherical shape as in the ε-iron oxide particles). First, the magnetic recording medium to be measured is processed by an FIB (Focused Ion Beam) method or the like to prepare a slice, and the cross section of the slice is observed by TEM. Next, 50 magnetic powders are randomly selected from the obtained TEM photograph, and a major axis length DL and a minor axis length DS of each of the magnetic powders are measured. Here, the major axis length DL means the largest one (so-called maximum Feret diameter) of the distances between two parallel lines drawn from all angles so as to be in contact with the contour of the magnetic powder. Meanwhile, the minor axis length DS means the largest one of the lengths of the magnetic powder in a direction perpendicular to the major axis of the magnetic powder.

Subsequently, the measured major axis lengths DL of the 50 magnetic powders are simply averaged (arithmetically averaged) to obtain an average major axis length DLave. Then, the average major axis length DLave obtained in this manner is used as the average particle size of the magnetic powder. Further, the measured minor axis lengths DS of the 50 magnetic powders are simply averaged (arithmetically averaged) to obtain an average minor axis length DSave. Next, an average aspect ratio (DLave/DSave) of the magnetic powder is obtained on the basis of the average major axis length DLave and the average minor axis length DSave.

Next, an average volume (particle volume) Vave of the magnetic powder is obtained from the following formula by using the average major axis length DLave.

Vave=n/6×DLave³

In this description, the case where the s-iron oxide particles each include a shell portion having a two-layer structure has been described. However, the ε-iron oxide particles may each include a shell portion having a single-layer structure. In this case, the shell portion has a configuration similar to that of the first shell portion. However, from the viewpoint of suppressing the characteristic deterioration of the ε-iron oxide particles, it is favorable that the ε-iron oxide particles each include a shell portion having a two-layer structure as described above.

In the above description, the case where the ε-iron oxide particles each have a core-shell structure has been described. However, the ε-iron oxide particles may contain an additive instead of the core-shell structure or may contain an additive while having a core-shell structure. In this case, some Fe of the s-iron oxide particles are substituted by the additives. Also by causing the ε-iron oxide particles to contain an additive, the coercive force Hc of the ε-iron oxide particles as a whole can be adjusted to the coercive force Hc suitable for recording, and thus, the ease of recording can be improved. The additive is a metal element other than iron, favorably a trivalent metal element, more favorably at least one of Al, Ga, or In, and still more favorably at least one of Al or Ga.

Specifically, the ε-iron oxide containing the additive is ε-Fe₂₋ₓMₓO₃ crystal (However, M represents a metal element other than iron, favorably a trivalent metal element, more favorably at least one of Al, Ga or In, and still more favorably at least one of Al or Ga. x satisfies the following formula represented by: 0<x<1, for example).

The magnetic powder may contain a powder of nanoparticles (hereinafter, referred to as “hexagonal ferrite particles”) containing hexagonal ferrite. The hexagonal ferrite particles each have, for example, a hexagonal plate shape or a substantially hexagonal plate shape. The hexagonal ferrite favorably contains at least one of Ba, Sr, Pb, or Ca, more favorably at least one of Ba or Sr. The hexagonal ferrite may specifically be, for example, barium ferrite or strontium ferrite. Barium ferrite may further contain at least one of Sr, Pb, or Ca, in addition to Ba. Strontium ferrite may further contain at least one of Ba, Pb, or Ca, in addition to Sr.

More specifically, the hexagonal ferrite has an average composition represented by the following general formula represented by: MFe₁₂O₁₉. However, M represents, for example, at least one metal selected from the group consisting of Ba, Sr, Pb, and Ca, favorably at least one metal selected from the group consisting of Ba and Sr. M may represent a combination of Ba and one or more metals selected from the group consisting of Sr, Pb, and Ca. Further, M may represent a combination of Sr and one or more metals selected from the group consisting of Ba, Pb, and Ca. In the general formula described above, some Fe may be substituted by other meatal elements.

In the case where the magnetic powder contains a powder of hexagonal ferrite particles, the average particle size of the magnetic powder is favorably 50 nm or less, more favorably 10 nm or more and 40 nm or less, and still more favorably 15 nm or more and 30 nm or less. In the case where the magnetic powder contains a powder of hexagonal ferrite particles, the average aspect ratio of the magnetic powder and the average volume Vave of the magnetic powder are as described above.

Note that the average particle size, the average aspect ratio, and the average volume Vave of the magnetic powder are obtained as follows (e.g., in the case where the magnetic powder has a plate-like shape as in hexagonal ferrite). First, the magnetic recording medium to be measured is processed by an FIB method or the like to prepare a slice, and the cross section of the slice is observed by TEM. Next, 50 magnetic powders oriented at an angle of 75 degrees or more with respect to the horizontal direction are randomly selected from the obtained TEM photograph, and a maximum plate thickness DA of each magnetic powder is measured. Subsequently, the measured maximum plate thicknesses DA of the 50 magnetic powders are simply averaged (arithmetically averaged) to obtain an average maximum plate thickness DAave.

Next, the surface of the magnetic layer of the magnetic recording medium is observed by TEM. Next, 50 magnetic powders are randomly selected from the obtained TEM photograph, and a maximum plate diameter DB of each magnetic powder is measured. Here, the maximum plate diameter DB means the largest one (so-called maximum Feret diameter) of the distances between two parallel lines drawn from all angles so as to be in contact with the contour of the magnetic powder. Subsequently, the measured maximum plate diameters DB of the 50 magnetic powders are simply averaged (arithmetically averaged) to obtain an average maximum plate diameter DBave. Then, the average maximum plate diameter DBave obtained in this manner is used as the average particle size of the magnetic powder. Next, an average aspect ratio (DBave/DAave) of the magnetic powder is obtained on the basis of the average maximum plate thickness DAave and the average maximum plate diameter DBave.

Next, using the average maximum plate thickness DAave and the average maximum plate diameter DBave, an average volume (particle volume) Vave of the magnetic powder is obtained from the following formula.

Vave=3√3/8×DAave×DBave²

The magnetic powder may contain a powder of nanoparticles (hereinafter, referred to as “cobalt ferrite particles”) containing Co-containing spinel ferrite. The cobalt ferrite particles favorably have uniaxial anisotropy. The cobalt ferrite particles each have, for example, a cubic shape or a substantially cubic shape. The Co-containing spinel ferrite may further contain at least one of Ni, Mn, Al, Cu, or Zn, in addition to Co.

The Co-containing spinel ferrite has, for example, the average composition represented by the following formula (1).

CoₓM_{y}Fe₂O_{z} (1)

(However, in the formula (1), M represents, for example, at least one metal selected from the group consisting of Ni, Mn, Al, Cu, and Zn. x represents a value within the range of 0.4≤x≤1.0. y represents a value within the range of 0≤y≤0.3. However, x and y satisfy the relationship represented by the following formula: (x+y)≤1.0. z represents a value within the range of 3≤z≤4. Some Fes may be substituted with other metal elements.)

In the case where the magnetic powder contains a powder of cobalt ferrite particles, the average particle size of the magnetic powder is favorably 25 nm or less, more favorably 23 nm or less. In the case where the magnetic powder contains a powder of cobalt ferrite particles, the average aspect ratio of the magnetic powder is determined by the above-mentioned method, and the average volume Vave of the magnetic powder is determined by the method shown below.

Note that in the case where the magnetic powder has a cubic shape as in cobalt ferrite particles, the average volume (particle volume) Vave of the magnetic powder can be obtained as follows. First, the surface of the magnetic layer of the magnetic recording medium is observed by TEM. Then, 50 magnetic powders are randomly selected from the obtained TEM photograph, and a side length DC of each of the magnetic powders is measured. Subsequently, the measured side lengths DC of the 50 magnetic powders are simply averaged (arithmetically averaged) to obtain an average side length DCave. Next, using the average side length DCave, the average volume (particle volume) Vave of the magnetic powder is obtained from the following formula.

### Vave=DCave³

(Binder)

As the binder, a resin having a structure in which a crosslinking reaction is imparted to a polyurethane resin, a vinyl chloride resin, or the like is favorable. However, the binder is not limited thereto, and another resin may be appropriately mixed in accordance with the physical properties required for the magnetic recording medium. The resin to be mixed is not particularly limited as long as it is a resin generally used in the coating-type magnetic recording medium.

Examples of the resin include polyvinyl chloride, polyvinyl acetate, a vinyl chloride-vinyl acetate copolymer, a vinyl chloride-vinylidene chloride copolymer, a vinyl chloride-acrylonitrile copolymer, an acrylic acid ester-acrylonitrile copolymer, an acrylic acid ester-vinyl chloride-vinylidene chloride copolymer, a vinyl chloride-acrylonitrile copolymer, an acrylic acid ester-acrylonitrile copolymer, an acrylic acid ester-vinylidene chloride copolymer, a methacrylic acid ester-vinylidene chloride copolymer, a methacrylic acid ester-vinyl chloride copolymer, a methacrylic acid ester-ethylene copolymer, polyvinyl fluoride, a vinylidene chloride-acrylonitrile copolymer, an acrylonitrile-butadiene copolymer, a polyamide resin, polyvinyl butyral, cellulose derivatives (cellulose acetate butyrate, cellulose diacetate, cellulose triacetate, cellulose propionate, nitrocellulose), a styrene butadiene copolymer, a polyester resin, an amino resin, and synthetic rubber.

Further, examples of the thermosetting resin or the reactive resin include a phenol resin, an epoxy resin, a urea resin, a melamine resin, an alkyd resin, a silicone resin, a polyamine resin, and a urea formaldehyde resin.

Further, a polar functional group such as —SO₃M, —OSO₃M, —COOM, and P═O(OM)₂ may be introduced into the above-mentioned binders for the purpose of improving dispersibility of the magnetic powder. Here, M in the formula represents a hydrogen atom, or an alkali metal such as lithium, potassium, and sodium.

Further, examples of the polar functional groups include those of the side chain type having the terminal group of —NR1R2 or —NR1R2R3⁺X⁻ and those of the main chain type having >NR1R2⁺X⁻. Here, R1, R2, and R3 in the formula each represent a hydrogen atom or a hydrocarbon group, and X⁻ represents a halogen element ion such as fluorine, chlorine, bromine, and iodine, or an inorganic or organic ion. Further, examples of the polar functional groups include also —OH, —SH, —CN, and an epoxy group.

(Lubricant)

It is favorable that the lubricant contains a compound represented by the following general formula (1) and a compound represented by the following general formula (2). In the case where the lubricant contains these compounds, it is possible to particularly reduce the dynamic friction coefficient of the surface of the magnetic layer. Therefore, it is possible to further improve the traveling property of the magnetic recording medium.

CH₃(CH₂)ₙCOOH (1)

(However, in the general formula (1), n represents an integer selected from the range of 14 or more and 22 or less.)

CH₃(CH₂)ₚCOO(CH₂)_{q}CH₃ (2)

(However, in the general formula (2), p represents an integer selected from the range of 14 or more and 22 or less, and q represents an integer selected from the range of 2 or more and 5 or less.)

(Additive)

The magnetic layer may further contain, as non-magnetic reinforcing particles, aluminum oxide (α, β, or γ-alumina), chromium oxide, silicon oxide, diamond, garnet, emery, boron nitride, titanium carbide, silicon carbide, titanium carbide, titanium oxide (rutile or anatase-type titanium oxide), or the like.

[Non-Magnetic Layer]

The non-magnetic layer contains a non-magnetic powder and a binder. The non-magnetic layer may contain an additive such as conductive particles, a lubricant, a curing agent, and a rust prevention material as necessary.

The thickness of the non-magnetic layer is favorably 0.6 μm or more and 2.0 μm or less, more favorably 0.8 μm or more and 1.4 μm or less. The thickness of the non-magnetic layer can be obtained by a method similar to the method of obtaining the thickness of the magnetic layer (e.g., TEM). Note that the magnification of the TEM image is appropriately adjusted in accordance with the thickness of the non-magnetic layer.

(Non-Magnetic Powder)

The non-magnetic powder includes, for example, at least one of an inorganic particle powder or an organic particle powder. Further, the non-magnetic powder may contain a carbon material such as carbon black. Note that one type of non-magnetic powder may be used alone, or two or more types of non-magnetic powders may be used in combination. The inorganic particles include, for example, a metal, a metal oxide, a metal carbonate, a metal sulfate, a metal nitride, a metal carbide, or a metal sulfide. Examples of the shape of the non-magnetic powder include, but not limited to, various shapes such as a needle shape, a spherical shape, a cubic shape, and a plate shape.

(Binder)

The binder is similar to that in the above-mentioned magnetic layer.

[Back Layer]

The back layer contains a non-magnetic layer and a binder. The back layer may contain an additive such as a lubricant, a curing agent, and an antistatic agent, as necessary. As the non-magnetic powder and the binder, materials similar to those used in the above-mentioned non-magnetic layer are used.

(Non-Magnetic Powder)

The average particle size of the non-magnetic powder is favorably 10 nm or more and 150 nm or less, more favorably 15 nm or more and 110 nm or less. The average particle size of the magnetic powder is obtained in a way similar to that for the average particle size D of the magnetic powder described above. The non-magnetic powder may include a non-magnetic powder having two or more particle size distributions.

The upper limit value of the average thickness of the back layer is favorably 0.6 μm or less. When the upper limit value of the average thickness of the back layer is 0.6 μm or less, since the thicknesses of the non-magnetic layer and the base material can be kept thick even in the case where the average thickness of the magnetic recording medium is 5.6 μm, it is possible to maintain the traveling stability of the magnetic recording medium in the recording/reproduction device. The lower limit value of the average thickness of the back layer is not particularly limited, but is, for example, 0.2 μm or more.

The average thickness of the back layer is obtained as follows. First, a magnetic recording medium having a ½ inch width is prepared, and cut into a length of 250 mm to prepare a sample. Next, using a laser hologage manufactured by Mitutoyo as a measuring device, the thickness of the sample is measured at five or more points, and these measured values are simply averaged (arithmetically averaged) to calculate an average value t_{T} [μm] of the magnetic recording medium. Note that the measurement positions are randomly selected from the sample. Subsequently, the back layer of the sample is removed with a solvent such as MEK (methyl ethyl ketone) and dilute hydrochloric acid. After that, the thickness of the sample is measured at five or more points by using the laser hologage described above again, and these measured values are simply averaged (arithmetically averaged) to calculate an average value t_{B} [μm] of the magnetic recording medium from which the back layer has been removed. Note that the measurement positions are randomly selected from the sample. After that, an average thickness t_{b} [μm] of the back layer is obtained from the following formula.

t_{b}[μm]=t_{T}[μm]−t_{B}[μm]

The back layer has a surface in which a large number of protruding portions are provided. The large number of protruding portions are for forming a large number of holes on the surface of the magnetic layer while the magnetic recording medium is wound in a roll. The large number of holes are formed by, for example, a large number of non-magnetic particles protruding from the surface of the back layer.

In this description, the case where a large number of protruding portions provided on the surface of the back layer are transferred to the surface of magnetic layer to form a large number of holes on the surface of the magnetic layer has been described, but the method of forming a large number of holes is not limited thereto. For example, a large number of holes may be formed on the surface of the magnetic layer by adjusting the type of the solvent contained in the coating material for forming a magnetic layer, the drying condition of the coating material for forming a magnetic layer, and the like.

[Average Thickness of Magnetic Recording Medium]

The upper limit value of the average thickness (average total thickness) of the magnetic recording medium is favorably 5.6 μm or less, more favorably 5.0 μm or less, more favorably 4.6 μm or less, and still more favorably 4.4 μm or less. When the average thickness of the magnetic recording medium is 5.6 μm or less, the recording capacity in a cartridge can be made higher than that in a general magnetic recording medium. The lower limit value of the average thickness of the magnetic recording medium is not particularly limited, but is, for example, 3.5 μm or more.

The average thickness of the magnetic recording medium is obtained by the procedure described in the above-mentioned method of obtaining the average thickness of the back layer.

It should be noted that the present technology may also take the following configurations.

(1) A tape cartridge, including:

a first flange;

a second flange; and

a reel hub on which a tape is wound, the reel hub being disposed between the first flange and the second flange, in which

the reel hub includes
a cylindrical metal ring, and
a molded body formed of a synthetic resin, the molded body including a first resin portion formed on an inner peripheral surface of the metal ring and a second resin portion formed on an outer peripheral surface of the metal ring, and
the first resin portion includes a plurality of first recessed portions formed at intervals in a circumferential direction of the metal ring.
   (2) The tape cartridge according to (1) above, in which

the plurality of first recessed portions includes groove portions extending in an axial direction of the metal ring.

(3) The tape cartridge according to (2) above, in which

the plurality of first recessed portions is formed from one end of the first resin portion in the axial direction to a vicinity of the other end of the first resin portion in the axial direction.

(4) The tape cartridge according to (2) or (3) above, in which

the molded body further includes a third resin portion formed on a surface of the metal ring on one end side in the axial direction, and

the third resin portion includes a plurality of holes formed at intervals in a circumferential direction of the metal ring.

(5) The tape cartridge according to any one of (2) to (4) above, in which

the first flange includes a plurality of protruding portions that protrudes toward the one end of the first resin portion in the axial direction, and

the first resin portion further includes a plurality of second recessed portions that engages with the plurality of protruding portions.

(6) The tape cartridge according to (5) above, in which

the plurality of second recessed portions includes groove portions common to the plurality of first recessed portions.

(7) The tape cartridge according to any one of (1) to (6) above, in which

the first flange includes a plurality of first engagement portions provided radially inward of the reel hub,

the second flange includes a plurality of second engagement portions that is provided radially inward of the reel hub and engages with the plurality of first engagement portions, and

the reel hub is disposed between the first flange and the second flange coupled to each other via the plurality of first engagement portions and the plurality of second engagement portions.

(8) A tape reel, including:

a first flange;

a second flange; and

a reel hub disposed between the first flange and the second flange, in which

the reel hub includes
a cylindrical metal ring, and
a molded body formed of a synthetic resin, the molded body including a first resin portion formed on an inner peripheral surface of the metal ring and a second resin portion formed on an outer peripheral surface of the metal ring, and

the first resin portion includes a plurality of first recessed portions formed at intervals in a circumferential direction of the metal ring.

(9) A method of producing a reel hub, including:

disposing a metal ring in a first mold that includes a columnar portion facing an inner peripheral surface of the metal ring, a first base portion that is integrally formed with the columnar portion and faces one end of the metal ring in an axial direction, and a plurality of ridges that extends along the axial direction and protrudes from an outer peripheral surface of the columnar portion toward the inner peripheral surface of the metal ring;

combining a second mold with the first mold, the second mold including a cylindrical portion facing an outer peripheral surface of the metal ring and a second base portion that is integrally formed with the cylindrical portion and faces the other end of the metal ring in the axial direction; and

injecting a synthetic resin material between an outer periphery portion of the columnar portion and an inner peripheral surface of the cylindrical portion via an injection port formed between the columnar portion and the second base portion.

(10) the Method of Producing a Reel Hub According to (9) above, in which

the injection port is formed along an entire circumference of the other end of the metal ring.

(11) The method of producing a reel hub according to (9) or (10) above, in which

the first base portion includes a plurality of protruding portions that supports the surface of the metal ring on the one end side.

### REFERENCE SIGNS LIST

1 tape cartridge
6, 600 reel hub
7 upper flange (second flange)
8 lower flange (first flange)
22 magnetic tape
91 first mold
92 second mold
610 metal ring
620 molded body
621 first resin portion
622 second resin portion
623 third resin portion
624 fourth resin portion
651 positioning recessed portion (first recessed portion)
652 engagement recessed portion (second recessed portion)
653 hole
911 first base portion
912 core portion (columnar portion)
913 ridge
914 projecting portion
915 protruding portion

1. A tape cartridge, comprising:
a first flange;
a second flange; and
a reel hub on which a tape is wound, the reel hub being disposed between the first flange and the second flange, wherein
the reel hub includes
a cylindrical metal ring, and
a molded body formed of a synthetic resin, the molded body including a first resin portion formed on an inner peripheral surface of the metal ring and a second resin portion formed on an outer peripheral surface of the metal ring, and
the first resin portion includes a plurality of first recessed portions formed at intervals in a circumferential direction of the metal ring.

2. The tape cartridge according to claim 1, wherein
the plurality of first recessed portions includes groove portions extending in an axial direction of the metal ring.

3. The tape cartridge according to claim 2, wherein
the plurality of first recessed portions is formed from one end of the first resin portion in the axial direction to a vicinity of the other end of the first resin portion in the axial direction.

4. The tape cartridge according to claim 2, wherein
the molded body further includes a third resin portion formed on a surface of the metal ring on one end side in the axial direction, and
the third resin portion includes a plurality of holes formed at intervals in a circumferential direction of the metal ring.

5. The tape cartridge according to claim 2, wherein
the first flange includes a plurality of protruding portions that protrudes toward the one end of the first resin portion in the axial direction, and
the first resin portion further includes a plurality of second recessed portions that engages with the plurality of protruding portions.

6. The tape cartridge according to claim 5, wherein
the plurality of second recessed portions includes groove portions common to the plurality of first recessed portions.

7. The tape cartridge according to claim 1, wherein
the first flange includes a plurality of first engagement portions provided radially inward of the reel hub,
the second flange includes a plurality of second engagement portions that is provided radially inward of the reel hub and engages with the plurality of first engagement portions, and
the reel hub is disposed between the first flange and the second flange coupled to each other via the plurality of first engagement portions and the plurality of second engagement portions.

8. A tape reel, comprising:
a first flange;
a second flange; and
a reel hub disposed between the first flange and the second flange, wherein
the reel hub includes
a cylindrical metal ring, and
a molded body formed of a synthetic resin, the molded body including a first resin portion formed on an inner peripheral surface of the metal ring and a second resin portion formed on an outer peripheral surface of the metal ring, and
the first resin portion includes a plurality of first recessed portions formed at intervals in a circumferential direction of the metal ring.

9. A method of producing a reel hub, comprising:
disposing a metal ring in a first mold that includes a columnar portion facing an inner peripheral surface of the metal ring, a first base portion that is integrally formed with the columnar portion and faces one end of the metal ring in an axial direction, and a plurality of ridges that extends along the axial direction and protrudes from an outer peripheral surface of the columnar portion toward the inner peripheral surface of the metal ring;
combining a second mold with the first mold, the second mold including a cylindrical portion facing an outer peripheral surface of the metal ring and a second base portion that is integrally formed with the cylindrical portion and faces the other end of the metal ring in the axial direction; and
injecting a synthetic resin material between an outer periphery portion of the columnar portion and an inner peripheral surface of the cylindrical portion via an injection port formed between the columnar portion and the second base portion.

10. The method of producing a reel hub according to claim 9, wherein
the injection port is formed along an entire circumference of the other end of the metal ring.

11. The method of producing a reel hub according to claim 9, wherein
the first base portion includes a plurality of protruding portions that supports the surface of the metal ring on the one end side.
